(19) United States
(12) Patent Application Publication
(10) Pub. No.: US 2015/0101938 A1
(43) Pub. Date: Apr. 16, 2015

(54) Measurement device with automated calibration

(71) Applicant: pHase2 microtechnologies, LLC, Boston, MA (US)

(72) Inventors: Valeriya Bychkova, Pittsburgh, PA (US); Sung Kwon Cho, Pittsburgh, PA (US); William Clark, Wexford, PA (US); J. Christopher Flaherty, Auburndale, FL (US); R. Maxwell Flaherty, Auburndale, FL (US); Ashley Mcconnell, Pittsburgh, PA (US); Alexander Star, Pittsburgh, PA (US); Timothy J. Syciarz, Pittsburgh, PA (US); David Wagner, Boston, MA (US); Yuejun Zhao, Pittsburgh, PA (US)

(73) Assignee: pHase2 microtechnologies, LLC, Boston, MA (US)

(21) Appl. No.: 14/395,051

(22) PCT Filed: Mar. 15, 2013
(86) PCT No.: PCT/US2013/031902

§ 371 Date: Oct. 16, 2014

Related U.S. Application Data
(60) Provisional application No. 61/624,617, filed on Apr. 16, 2012.

(51) Int. Cl. G01N 27/416; G01N 27/30

(52) U.S. Cl. CPC G01N 27/4165; G01N 27/302
USPC 205/787.5; 204/433

(57) ABSTRACT

A system for obtaining a pH measurement comprises a disposable probe and a reusable reader. The disposable probe includes an indicating electrode and a reference electrode. The reader operably engages the disposable probe and provides pH information of a sample. The system is configured to be self-calibrating. The system is constructed and arranged to provide pH information based on the potentiometric measurement of the sample solution based on signals received from the at least one indicating electrode and the at least one reference electrode.

### CROSS-REFERENCE TO RELATED APPLICATIONS

This application claims priority to and the benefit of, and incorporates herein by reference in its entirety, U.S. Provisional Patent Application No. 61/624,617, which was filed on Apr. 16, 2012. This application is related to PCT Application Serial No. PCT/US2012/53902, entitled MEASUREMENT DEVICE WITH SENSOR ARRAY, by Clark et al, filed Sep. 6, 2012, and PCT Application Serial No. PCT/US2012/53905, entitled MEASUREMENT DEVICE WITH READER AND DISPOSABLE PROBE, by Clark et al, filed Sep. 6, 2012, the contents of which are incorporated herein by reference in their entirety.

### BACKGROUND OF THE INVENTION

The following information is provided to assist the reader to understand the technology described below and certain environments in which such technology can be used. The terms used herein are not intended to be limited to any particular narrow interpretation unless clearly stated otherwise in this document. References set forth herein may facilitate understanding of the technology or the background thereof. The disclosures of all references cited herein are incorporated by reference in their entirety.

A typical pH sensor based on potentiometric principles includes a reference electrolyte solution, an indicating electrode immersed in or in contact with an analyte solution (of which the pH is to be measured), a reference electrode immersed in the reference electrolyte solution, and measurement circuitry such as potentiometric circuitry in electrical connection with the reference electrode and the indicating electrode. The potentiometric circuitry measures the electrical difference between the indicating and reference electrodes. Ionic contact between the electrolyte solutions in which the indicating electrode and the reference electrodes are immersed provides electrical connection between the electrodes. The pH value of the sample or analyte electrolyte solution (which is proportional to concentration of the hydrogen ions in the sample electrolyte) is directly correlated with the potential difference developed at the indicating electrode following the Nernst equation.

The accuracy of measurement obtained with a pH sensor can be adversely affected by degradation of the sensor over time. For these and other reasons, calibration near the time of measurement can be required, and it is desirable to provide a reliable self-calibrating sensor.

### SUMMARY

According to an aspect of the invention, a system for determining a pH measurement comprises a disposable probe and a reader configured to operably engage with the disposable probe and provide pH information of a sample, where the disposable probe comprises an indicating electrode and a reference electrode. In some embodiments, the system includes two or more indicating electrodes. In some embodiments, the system includes two or more reference electrodes.

In some embodiments, the system is configured to provide the pH information based on potentiometric measurement of the sample solution based on signals received from the at least one indicating electrode and the at least one reference electrode when the at least one reference electrode is in contact with a reference solution and when the at least one indicating electrode is in contact with the sample.

In some embodiments, the system is configured to provide the pH information based on amperometric measurement of the sample solution based on signals received from the at least one indicating electrode and the at least one reference electrode when the at least one reference electrode is in contact with a reference solution and when the at least one indicating electrode is in contact with the sample.

In some embodiments, the system is configured to provide the pH information based on resistive measurement of the sample solution based on signals received from the at least one indicating electrode and the at least one reference electrode when the at least one reference electrode is in contact with a reference solution and when the at least one indicating electrode is in contact with the sample.

In some embodiments, the system is configured to provide the pH information based on measurement of the sample solution based on signals received from the at least one indicating electrode and the at least one reference electrode when the at least one reference electrode is in contact with a reference solution and when the at least one indicating electrode is in contact with the sample.

The system can further comprise a storage assembly configured to store and/or dispense the disposable probe. The system can further comprise at least a second disposable probe, where the storage assembly is further configured to store the at least second disposable probe. The storage assembly can comprise a first capture element, and the disposable probe can comprise a second capture element configured to be captured by the storage assembly first capture element. The first and second capture elements can comprise components selected from the group consisting of: magnetic coupling components; snap fit coupling components; frictionally engaging components; hook and loop coupling components, such as Velcro; and combinations of these. The storage assembly can comprise a control configured to translate and/or rotate the disposable probe. The storage assembly can comprise at least one reservoir, for example where the at least one reservoir comprises at least one reference solution. The storage assembly can comprise at least one pump assembly such as a pump assembly configured to pump reference solution to cover the reference electrode, the indicating electrode or both electrodes. The storage assembly can comprise a component and/or assembly selected from the group consisting of: analog circuitry; digital circuitry; a power supply such as a battery or capacitor; software; algorithms; one or more microcontrollers; and combinations of these. The storage assembly can comprise an exit port configured to allow the disposable probe to pass therethrough. The storage assembly can be configured to perform an operation selected from the group consisting of: delivery of a reference solution to the disposable probe such as a reference solution propelled from a reservoir by a pump; a calibration procedure; a voltage treatment such as a voltage treatment applied to the disposable probe by an electronics module; an activation procedure such as a procedure performed to prepare the disposable probe for pH measurement; and combinations of these.

The system can further comprise a second disposable probe. In this embodiment, the system can further comprise a storage assembly surrounding the first and second disposable probes. The disposable probe can be configured to provide individual pH measurements for multiple different samples. The disposable probe can comprise a releasable locking element configured to releasably lock the disposable probe to the reader. The disposable probe can comprise a puncturable access port, and in some embodiments, the reader comprises a puncture element configured to puncture the disposable probe access port and fluidly connect the disposable probe to the reader.

The indicating electrode can comprise a MEMS indicating electrode. The indicating electrode can be constructed of a material selected from the group consisting of: iridium oxide; silicon oxide such as doped silicon oxide; and combinations of these. The disposable probe can further comprise a fluidic channel comprising walls which continuously surround the indicating electrode. Alternatively, the fluidic channel walls can partially surround the indicating electrode.

In some embodiments, the disposable probe comprises a proximal portion and at least two attachable distal portions, such as two or more distal portions which are attached sequentially to perform two or more sequential pH measurements of a sample solution. In some embodiments, the at least two attachable distal portions comprise at least one of a reference electrode or an indicating electrode. In some embodiments, the at least two attachable distal portions comprise a reference electrode and an indicating electrode. The proximal portion can include a reservoir, such as a reservoir including at least one reference solution to be propelled to cover the indicating electrode. The system may include any number of attachable distal probe portions, such as at least 5, at least 20, at least 50 or at least 100 distal probe portions, each configured to operably attach to one or more probe proximal portions. The probe proximal portion may include a puncture element, such as a needle, to fluidly attach to each distal portion attached thereto. Numerous forms of connecting elements can be included, such as a pair of mating projecting and receiving elements mounted to either or both the proximal probe portion and each distal probe portion. The connecting elements can be configured to provide a connection selected from the group consisting of: a fluid connection; an electrical connection; an optical connection and combinations thereof.

The disposable probe may be configured to prevent mixing of fluids contained within the disposable probe. Prevention of mixing may be achieved by the geometry of one or more fluidic channels (e.g. by limiting cross sectional area); by keeping flow rates below a threshold; and/or with the inclusion of a permeable membrane such as a permeable membrane which allows conduction of electrical signals therethrough but limits fluid flow.

The system may include reference solution, such as reference solution contained in one or more reservoirs included in the reader and/or the disposable probe. The disposable probe may be provided with reference solution surrounding the reference electrode and/or the indicating electrode, or the probe may be provided with no reference solution surrounding the reference electrode and/or the indicating electrode.

The reference electrode can comprise a MEMS reference electrode. The reference electrode can be constructed of materials selected from the group consisting of: iridium oxide; silicon oxide such as doped silicon oxide; silver/silver chloride (Ag/AgCl); and combinations of these. The reference electrode can comprise a first material and the indicating electrode can comprise a second material, where the first and second materials can be similar or dissimilar.

The disposable probe can further comprise a fluidic channel comprising walls which continuously surround the reference electrode. Alternatively, the fluidic channel walls can partially surround the reference electrode.

In some embodiments, the reference electrode can be positioned within 1 mm of the indicating electrode. In other embodiments, the reference electrode is positioned at a location greater than 1 mm from the indicating electrode.

The disposable probe can further comprise at least a second electrode. In this embodiment, a first and at least a second electrode can be fluidly connected to the indicating electrode. The system can be configured to expose the first reference electrode to a first reference solution and the second reference electrode to a second reference solution where the first reference solution comprises a first pH and where the second reference solution comprises a second, different pH. The system can be configured to perform a best fit algorithm to determine the pH measurement.

The system can further comprise a fluidic channel, where the system is configured to transport reference solution through at least a portion of the fluidic channel. The reader can comprise a reservoir containing reference solution, and the system can be configured to transport the reference solution between the reservoir and the reference electrode. The system can be configured to transport reference solution from the reference electrode to the indicating electrode and/or from the indicating electrode to the reference electrode. The fluidic channel can be configured to maintain laminar fluid within the fluidic channel. The system can be further configured to transport the sample through at least a portion of the fluidic channel. The fluidic channel can comprise a curvilinear pathway, for example a serpentine pathway. The fluidic channel can comprise a characteristic dimension with a length less than 1 cm, less than 1 mm, less than 1 micron, or less than 10 nanometers. The fluidic channel can comprise a segment with a reduced cross sectional area, for example an area less than or equal to half the area of another portion of the fluidic channel. The reduced area can be configured to limit diffusion between the reference electrode and the indicating electrode and/or increase flow proximate the indicating electrode and/or the reference electrode. The fluidic channel can comprise at least a portion that comprises a closed channel. The fluidic channel can comprise at least a portion that comprises a rectangular cross section.

The indicating electrode can comprise an exposed surface area positioned entirely within the fluidic channel. Alternatively, the indicating electrode can comprise an exposed surface area first portion positioned within the fluidic channel and an exposed surface area second portion positioned outside of the fluidic channel. In some embodiments, the indicating electrode can be positioned entirely outside of the fluidic channel.

The reference electrode can comprise an exposed surface area positioned entirely within the fluidic channel. Alternatively, the reference electrode can comprise an exposed surface area first portion positioned within the fluidic channel and an exposed surface area second portion positioned outside of the fluidic channel.

The fluidic channel can comprise a gate portion configured to minimize diffusion between the reference electrode and the reference electrode.

The system can further comprise a second fluidic channel. In this embodiment, the first fluidic channel can be configured to transport a first reference solution, and the second fluidic channel can be configured to transport a second reference solution, where the first reference solution and the second reference solution comprise a different pH and are each used to calibrate the disposable probe. The second fluidic channel can be parallel with the first fluidic channel, such as in providing an alternate flow pathway to the indicating electrode.

One or more valves can be included in one or more fluidic channels of the disposable probe. The valve can comprise an automatic valve; a manual valve; a one-way valve; or combinations of these.

A permeable membrane can be included in one or more fluidic channels of the disposable probe, such as a permeable membrane configured to minimize diffusion while allowing an electrical connection between either side of the permeable membrane. In some embodiments, the permeable membrane is constructed of materials selected from the group consisting of: Teflon; ceramic; glass; polyethylene; and combinations of these. The permeable membrane can be removable and/or insertable. A valve may be included such as a valve to permit and/or restrict flow around the permeable membrane.

The system can further comprise a liquid junction. The liquid junction can comprise a material configured to allow fluids to permeate therethrough. The liquid junction can be configured to prevent fluid mixing.

The system can further comprise a fluid reservoir. The fluid reservoir can comprise a supply of reference solution. The fluid reservoir can be configured to receive discarded fluid, for example a discarded reference solution. The fluid reservoir can be positioned in the reader or positioned in the disposable probe. In some embodiments, the reservoir is positioned in the disposable probe and a pumping element is included in the reader and configured to propel fluid contained in the disposable probe reservoir. The reservoir can comprise an attachable reservoir configured to be attached to the reader and/or the disposable probe. The system can further comprise a second fluid reservoir.

The system can further comprise a pumping element. The pumping element can be configured to pump fluid from the reader to the disposable probe and/or cause fluid to be drawn into the distal end of the disposable probe. The pumping element can comprise a component selected from the group consisting of: a syringe pump; a positive displacement pump; a pneumatic pump; an electrowetting mechanism; a syringe; a pipette; a micropipette; a chamber configured to be broken and/or compressed to deliver fluid; a plunger drive mechanism; a rotating or linear peristaltic drive; a magnetohydrodynamic drive; and combinations of these. At least a portion of the pumping element may be positioned in the reader, such as a portion which comprises a non-fluid contacting portion. At least a portion of the pumping element may be positioned in the disposable probe. In some embodiments, the pumping element includes a first portion positioned in the reader and a second portion positioned in the disposable probe.

The system can further comprise an error detection algorithm, for example an algorithm that is based on comparing a measured voltage to a threshold.

The reader can comprise a component selected from the group consisting of: a handheld reader; a benchtop reader; a high-throughput fluid test and/or measurement system; and combinations of these. The reader can be configured to provide information selected from the group consisting of: system readiness information; power level information such as battery level information; alert or alarm condition information; status of disposable probe such as number of uses remaining and/or the remaining life of the sensor; calibration information; and combinations of these. The reader can comprise a user interface. The reader can comprise a port configured to removably attach to the disposable probe, where the attachment can comprise a fluid and/or electrical attachment.

The system can be configured to perform a calibration operation. The calibration operation can be performed automatically, for example after the disposable probe is attached to the reader. Alternatively, the calibration operation can be initiated manually by an operator, for example via a control configured to initiate the calibration operation. The calibration operation can comprise pumping reference solution to cover the reference electrode and the indicating electrode. The dispensed reference solution for calibration purposes can be a pre-determined volume of fluid. The reference solution can be pumped in a feedback-controlled delivery method. The reference solution can be pumped based on a measured electrode response, such as a measured voltage exceeding a threshold.

The system can comprise a single point and/or multiple point calibration procedure. The system can comprise a calibration procedure and a calibration curve used to correlate a measured signal (e.g. a voltage or other measured signal) to pH. The system can comprise a calibration procedure configured to determine an offset by measuring a signal difference (e.g. a voltage) between the indicating electrode and the reference electrode when each is exposed to a reference solution with a known pH. For example, using potentiometric sensors such as IrOx indicating and reference electrodes, the system can comprise a calibration procedure including a first step comprising measuring a voltage between the indicating electrode and the reference electrode when each is exposed to a first reference solution and the voltage difference is representative of the offset or bias of the measurement system. The system can comprise a calibration procedure including a first step comprising measuring a signal difference (e.g. a voltage) between the indicating electrode and the reference electrode when each is exposed to a first reference solution and a second step comprising measuring a signal difference (e.g. a voltage) between the indicating electrode and the reference electrode when the reference electrode is exposed to a first reference solution and the indicating electrodes is exposed to a second reference solution, such as when the first reference solution comprises a first pH and the second reference solution comprises a second, different pH.

The system can comprise a multiple point calibration procedure. The system can comprise a calibration procedure based on a calibration curve used to correlate a measured signal (e.g. a voltage or other measured signal) to pH. The system can comprise a calibration procedure based on determining an offset and slope by measuring the signal between the indicating electrode and the reference electrode using two or more reference solutions with known pH values. For example, using potentiometric sensors such as IrOx indicating and reference electrodes, the system can comprise a calibration procedure including a first step comprising measuring a voltage between the indicating electrode and the reference electrode when each are exposed to a first reference solution and the voltage difference is representative of the offset or bias of the measurement system, and a second step comprising measuring a voltage between the indicating electrode exposed to a second reference solution of known different pH and the reference electrode exposed the first reference solution and the voltage difference is used with the voltage measured in the first step to determine the slope of the calibration curve. Additional reference solutions can be used in repeating the second step to gain more calibration points for more accurate calibration curve information.

The system can further comprise at least one reference solution. The at least one reference solution can comprise a solution selected from the group consisting of: a KCl solution; buffer solutions of varying chemical compositions; buffer solutions of varying pH; and combinations of these. The at least one reference solution can comprise a pH approximating an estimated pH of the sample, for example the estimated pH can differ from the sample by less than or equal to 1.0 pH.

The system can comprise a first reference solution and a second reference solution, where the first reference solution comprises a first pH and the second reference solution comprises a second, different pH.

The system can further comprise a self-diagnostic function. The self-diagnostic function can be configured to perform an operation selected from the group consisting of; confirming electrical connection between the indicating electrode and/or the reference electrode and the reader; recording and/or confirming a serial number of the probe; determining the configuration of the probe; and combinations of these.

The system can further comprise a removable cover surrounding at least the indicating electrode. The removable cover can be configured to create a fluid seal. The removable cover can comprise a peelably removable cover.

According to another aspect of the invention, a method for determining a pH measurement comprises providing a system for pH measurement, where the system comprises a disposable probe and a reader configured to operably engage with the disposable probe and provide pH, where the disposable probe comprises an indicating electrode and at least one reference electrode, and where the system is configured to be self-calibrating; inserting the disposable probe into the reader, and bringing the sample into contact with the indicating electrode.

The method can further comprise pumping a first reference solution over a reference electrode and the indicating electrode. A subsequent step can be performed in which the reference solution is withdrawn or otherwise removed to no longer cover the indicating electrode, such as while maintaining coverage of the reference electrode and/or maintaining contact between the reference solution and the sample. In this withdrawal step, simultaneous with withdrawal of the reference solution, sample solution may be drawn into the distal end of the disposable probe such as to cover the indicating electrode. Alternatively, the distal end of the probe can be dipped or otherwise placed into sample solution to cover the indicating electrode, such as when at least a portion of the indicating electrode is outside the fluidic channel. The method can further comprise pumping a second reference solution over the reference electrode. The second reference solution can be pumped over the same reference electrode that the first reference solution is pumped over. Alternatively, the second reference solution can be pumped over a different reference electrode that the first reference solution is pumped over. The pumping can be initiated automatically by the system, for example the pumping can be initiated by attaching the disposable probe to the reader. Alternatively, the pumping can be initiated manually by an operator.

The method can further comprise removing a cover to expose the indicating electrode after a calibration has been performed. The calibration can comprise a single point calibration procedure or a multiple point calibration procedure.

The bringing the sample solution into contact with the indicating electrode can comprise withdrawing fluid in a fluidic channel. Alternatively, the bringing the sample solution into contact with the indicating electrode can comprise placing the distal end of the probe into sample solution.

The method can further comprise placing a flow occluder in a fluidic pathway of the disposable probe, such as after a calibration procedure is performed.

The method can further comprise closing a valve positioned in a fluidic pathway, such as after a calibration procedure is performed.

According to another aspect of the present inventive concepts, a pH measurement system as described in reference to the drawings is provided.

According to another aspect of the present inventive concepts, a method of determining pH of a sample as described in reference to the drawings is provided.

The technology described herein, along with the attributes and attendant advantages thereof, will best be appreciated and understood in view of the following detailed description taken in conjunction with the accompanying drawings in which representative embodiments are described by way of example.

### BRIEF DESCRIPTION OF THE DRAWINGS

FIG. 1 illustrates a top view of a pH sensing system, consistent with the present inventive concepts.

FIG. 1A illustrates a sectional top view of the system of FIG. 1, consistent with the present inventive concepts.

FIG. 2 illustrates a flow chart of an algorithm for calibrating a pH sensing system, consistent with the present inventive concepts.

FIG. 3 is a graph of a calibration curve for a pH sensing system, consistent with the present inventive concepts.

FIGS. 4A and 4B illustrate top and side views, respectively, of a disposable pH sensing probe, consistent with the present inventive concepts.

FIG. 4C illustrates a top view of a disposable pH sensing probe including a permeable membrane and a flow diverting channel, consistent with the present inventive concepts.

FIG. 4D illustrates a top view of a disposable pH sensing probe including an operator insertable permeable membrane, consistent with the present inventive concepts.

FIGS. 5A and 5B illustrate top and side views, respectively, of a disposable pH sensing probe, consistent with the present inventive concepts.

FIG. 5C illustrates a side view of the disposable probe of FIGS. 5A and 5B, with a cover removed, consistent with the present inventive concepts.

FIGS. 5D and 5E illustrate top views of a disposable pH sensing probe, consistent with the present inventive concepts.

FIG. 6 illustrates an end view of a disposable pH sensing probe, consistent with the present inventive concepts.

FIG. 6A is a plot of voltage measurements recorded by a pH sensor, consistent with the present inventive concepts.

FIG. 7 is a flow chart of an error checking algorithm for a pH sensor, consistent with the present inventive concepts.

FIG. 8 is a perspective view of a disposable pH sensing probe portion and reusable access port, consistent with the present inventive concepts.

FIG. 8A is a perspective view of the disposable pH sensing probe portion of FIG. 8 inserted into the reusable access port, consistent with the present inventive concepts.

FIGS. 9A-9E illustrate sectional views of a pH sensing probe dispenser in multiple steps of operation, consistent with the present inventive concepts.

FIG. 10 illustrates a top view of a pH measurement system including a reusable reader and a two-piece insertable probe; consistent with the present inventive concepts.

FIGS. 10A and 10B illustrate top views of the pH measurement system of FIG. 10 wherein a reference solution is propelled through two stages of filling a fluidic channel, consistent with the present inventive concepts.

### DETAILED DESCRIPTION OF THE DRAWINGS

Reference will now be made in detail to the present embodiments of the technology, examples of which are illustrated in the accompanying drawings. The same reference numbers are used throughout the drawings to refer to the same or like parts.

The terminology used herein is for the purpose of describing particular embodiments and is not intended to be limiting of the inventive concepts. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

It will be understood that, although the terms first, second, third etc. can be used herein to describe various limitations, elements, components, regions, layers and/or sections, these limitations, elements, components, regions, layers and/or sections should not be limited by these terms. These terms are only used to distinguish one limitation, element, component, region, layer or section from another limitation, element, component, region, layer or section. Thus, a first limitation, element, component, region, layer or section discussed below could be termed a second limitation, element, component, region, layer or section without departing from the teachings of the present application.

It will be further understood that when an element is referred to as being “on” or “connected” or “coupled” to another element, it can be directly on or above, or connected or coupled to, the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). When an element is referred to herein as being “over” another element, it can be over or under the other element, and either directly coupled to the other element, or intervening elements may be present, or the elements may be spaced apart by a void or gap.

As used herein, “comparing to a threshold”, and a “threshold comparison” shall refer to comparing one or more values, such as one or more measured and/or calculated values, to a threshold. The threshold can comprise a single value, multiple values and/or a range of values. As used herein, “exceeding a threshold” can comprise a threshold comparison which determines if the one or more values are below a threshold, above a threshold, within a threshold comprising a range, or outside of a threshold comprising a range. Exceeding a threshold can be used to initiate, maintain and/or stop one or more events.

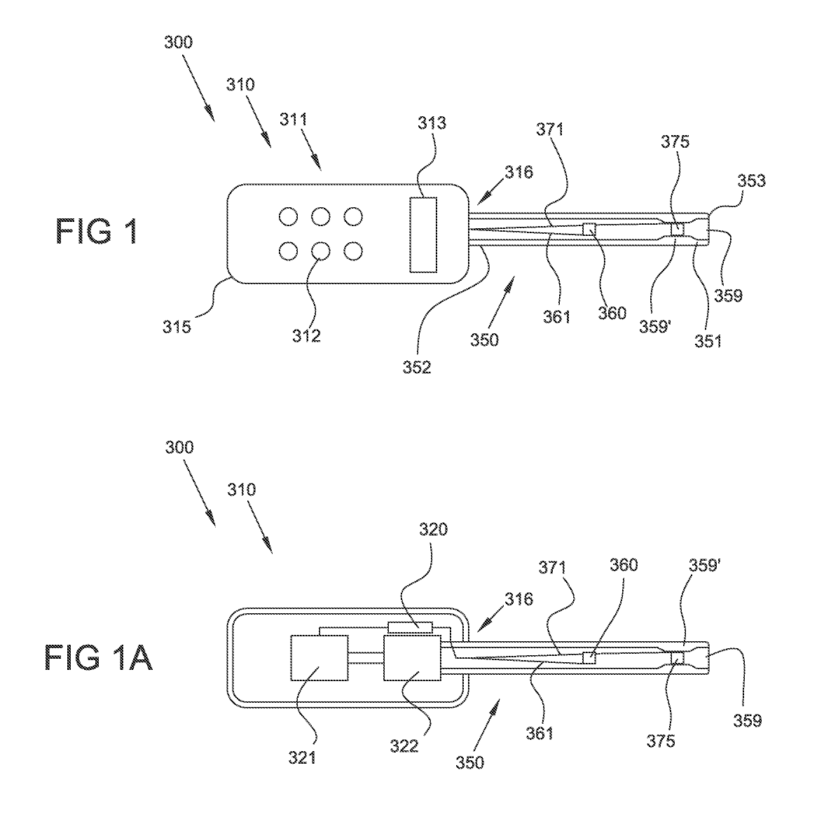

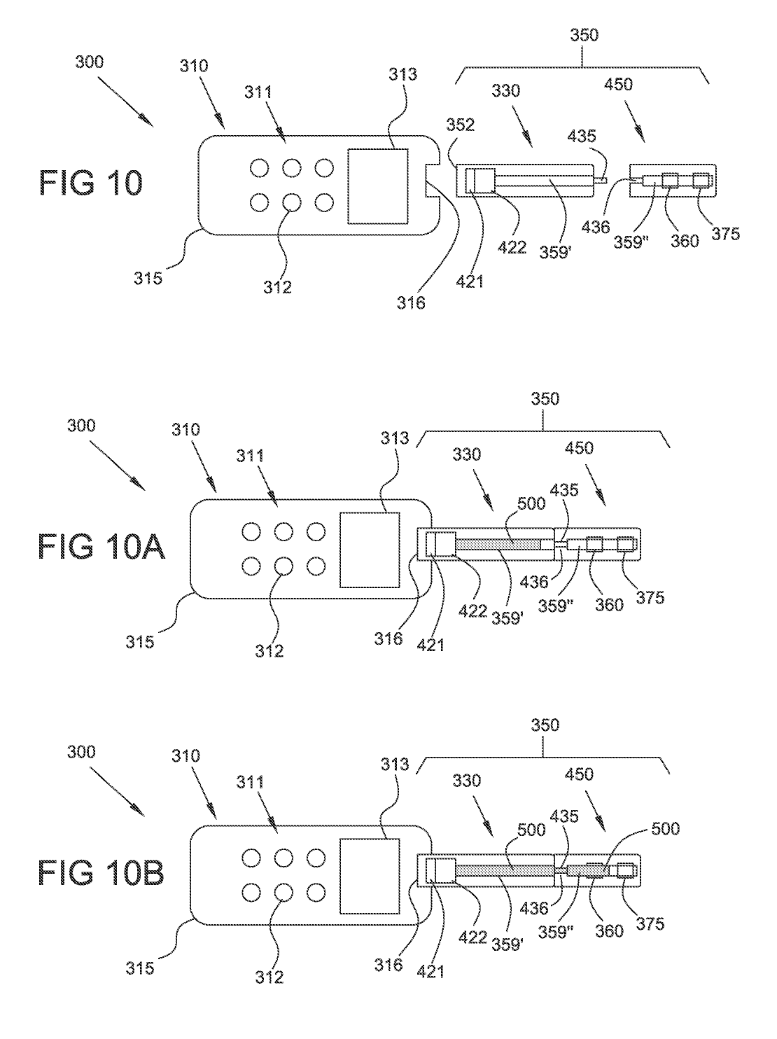

FIG. 1 is a top view of a pH measurement system, comprising a handheld device and a probe, configured to perform an automated calibration, according to the present inventive concepts. FIG. 1A is a sectional view of the system of FIG. 1, illustrating multiple components internal to the handheld device. System 300 includes reader 310 and insertable, disposable probe 350. Reader 310 comprises housing 315 which includes user interface 311. Housing 315 surrounds electronics module 320 which is operably connected to user interface 311, connections not shown but typically one or more electrical conduits such as wires, flex cables, and the like. Reader 310 can comprise the handheld configuration shown, or it can be provided in alternative forms such as when reader 310 is a benchtop unit or part of a high-throughput fluid test and/or measurement system. Reader 310 is constructed and arranged to allow multiple probes 350 to be used to measure pH of a sample, simultaneously or sequentially. Probes 350 can comprise multiple portions, such as multiple tip portions, each configured to be attached to the remaining portion of probe 350, such as is described in reference to FIG. 10 herebelow. Electronics module 320 is configured to be operably connected to probe 350. User interface 311 includes display 313 and buttons 312. Display 313, typically a liquid crystal or touch screen display, can display measured pH readings, as well as system and other information processed by electronics module 320. System information can include system input information and/or system output information such as information selected from the group consisting of: system readiness information; power level information such as battery level information; alert or alarm condition information; status of disposable probe such as number of uses remaining and/or the remaining life of the sensor; calibration information; and combinations of these.

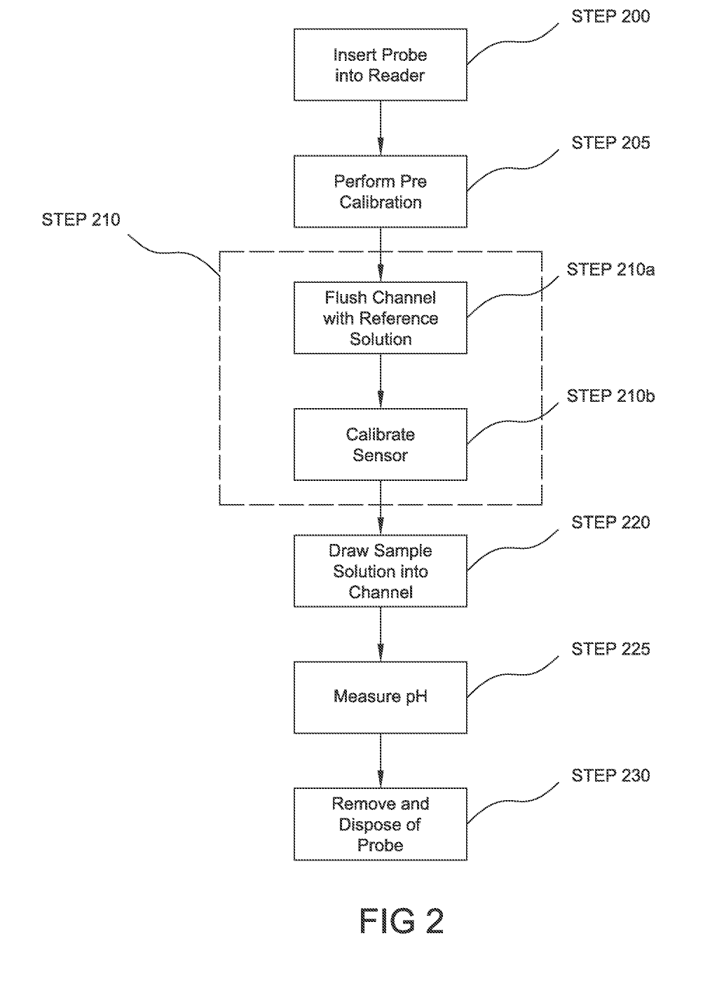

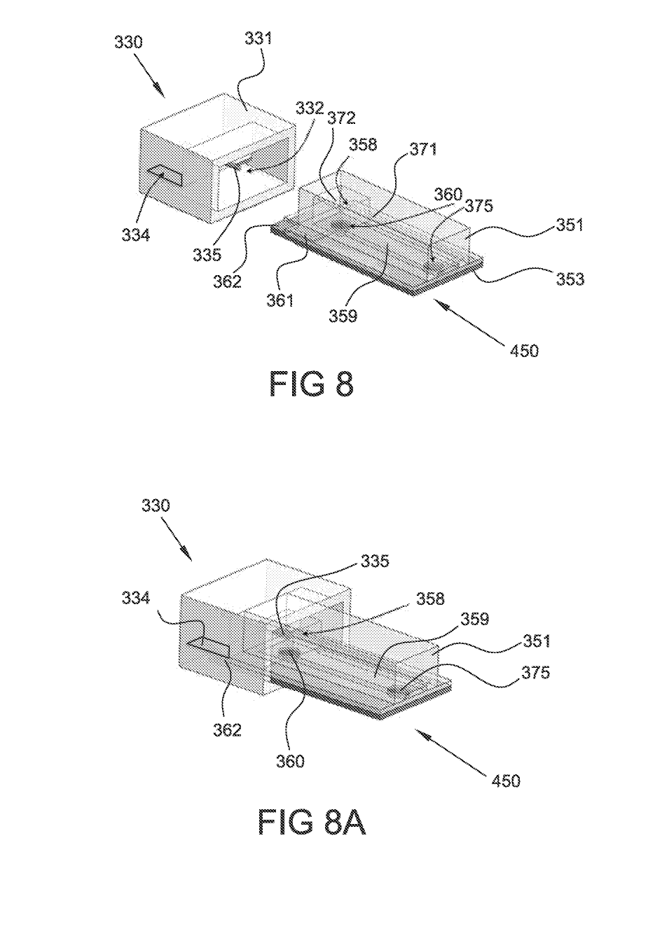

Housing 315 further includes an electromechanical port, port 316, configured to operably engage with the proximal end of disposable probe 350, such as to electrically and/or fluidly connect with one or more components internal to housing 315, such as to electrically connect to electronics module 320. In some embodiments, port 316 further comprises a liquid connection such as is described in reference to FIG. 8 herebelow. Probe 350 comprises housing 351, including proximal end 352 and distal end 353. Probe 350 further comprises indicating electrode 375, reference electrode 360, fluidic channel 359, and wires 361 and 371. Wire 361 and/or wire 371 can each include one or more electrical wires or one or more distinct electric pathways, such as one or more wires or electrically conductive pathways surrounded by an insulator. Wire 361 and/or wire 371 can comprise one or more electrical traces, such as one or more electrical traces separated by air or other insulating material to prevent shorting. Indicating electrode 375 comprises one or more indicating electrodes proximate the distal end 353 of probe 350. In some embodiments, indicating electrode 375 and/or reference electrode 360 comprise one or more electrodes manufactured in a microelectromechanical system (MEMS) fabrication process. Reference electrode 360 comprises one or more reference electrodes positioned at a distance from indicating electrode 375, such as reference electrode 360 positioned proximal to indicating electrode 375 as shown. The separation distance between reference electrode 360 and indicating electrode 375 can be selected to maximize accuracy, and may need to exceed a threshold (e.g. a minimum distance). Separation distance can be set above a length threshold to minimize adverse effects of reference and/or sample solution diffusion. Separation distance can be set below a length threshold to minimize volume of fluids needed and/or to minimize operational time spent during transfer of fluids such as reference solution pumping through channel 359. In some embodiments, reference electrode 360 comprises at least one reference electrode of similar configuration to at least one indicating electrode of indicating electrode 375. In other embodiments, indicating electrode 375 and reference electrode 360 can comprise dissimilar configurations, such as reference electrodes 360 comprising IrOx electrodes, electrodes comprising doped SiOx, and/or electrodes comprising Ag/AgCl. Wires 361 and 371 electrically connect electrodes 360 and 375, respectively, to electronics module 320 via port 316. Electronics module 320 is configured to determine calibration reference values, store calibration information, and determine pH values, such as is described in reference to FIG. 2 herebelow. Fluidic channel 359 can be configured to minimize mixing of two or more fluids (e.g. minimize mixing of sample and reference solutions while maintaining a patent liquid junction as is described herebelow) within channel 359, such as by preventing flow or maintaining flow in a laminar flow pattern. Channel 359 can comprise a closed channel (e.g. surrounded by a wall on all sides), an open channel (e.g. having one side open to the environment), or it can include both closed and open segments. Channel 359 can be defined using a characteristic dimension, as is known to those skilled in the art of microfluidics, such as a characteristic dimension comprising the cross sectional area of channel 359 divided by the wetted perimeter. In some embodiments, the height of fluidic channel 359 can be the characteristic dimension, such as embodiments where channel 359 comprises a rectangular cross sectional geometry, and the rectangle width is much larger than the height (e.g. 10 times larger). In some embodiments, the characteristic dimension is less than 1 cm, such as less than 1 mm. In some embodiments, the characteristic dimension is selected to maintain laminar flow of one or more fluids within the channel during use. In some embodiments, channel 359 can comprise a varied geometry pathway, such as a pathway with a serpentine pathway geometry. Channel 359 can comprise serpentine and/or other curvilinear pathway geometries configured to increase the length of channel 359 without increasing the surface area of probe 350. The length of channel 359 can be chosen to increase separation between the reference and indicating electrodes, allowing more analyte solution to “wash” the reference solution off of the indicating electrode as the fluid is pulled into the channel, such as to minimize error due to inadequate removal of reference solution.

Longer channels, such as a longer channel 359, can be configured to prevent undesired diffusion of one or more solutions maintained within channel 359, such as to increase allowable testing time, for example a test time of at least 1 minute, at least 3 minutes or at least 5 minutes. A longer channel can be used to prevent diffusion of reference solution and/or sample solution to the indicating and/or reference electrode, respectively, at which time a reading could be corrupted (e.g. to extend measurement time). In some embodiments, the segment length of fluidic channel 359 between indicating electrode 375 and reference electrode 360 can be within 1 mm or greater than 1 mm, such as greater than 2 mm or greater than 3 mm. In other embodiments, the length of channel 359 is limited, such as to minimize the time it takes one or more fluids to pass through the channel, such as is described herebelow when channel 359 includes a reduced area cross section.

In the embodiment of FIG. 1 and FIG. 1A, channel 359 includes a channel segment with a “necked” or narrowed cross sectional area, portion 359′. Portion 359′ generates a channel segment with an increased flow velocity, such as an increased flow velocity over indicating electrode 375 as shown. Portion 359′ can be sized to increase flow velocity of fluid passing over and/or around indicating electrode 375, to enhance the “washing” of indicating electrode 375. Portion 359′ can be less than 50 percent of the cross sectional area of channel 359, or less than 40 percent of the cross sectional area of channel 359, such as to increase flow velocity in an amount proportional to the decrease in cross sectional area. Electrodes 375 and 360 can be configured to reside entirely within channel 359, as shown in FIG. 1 and FIG. 1A. Alternatively, electrodes 375 and/or 360 can be configured to extend beneath the walls of channel 359, such as to be more easily positioned in channel 359 during manufacturing.

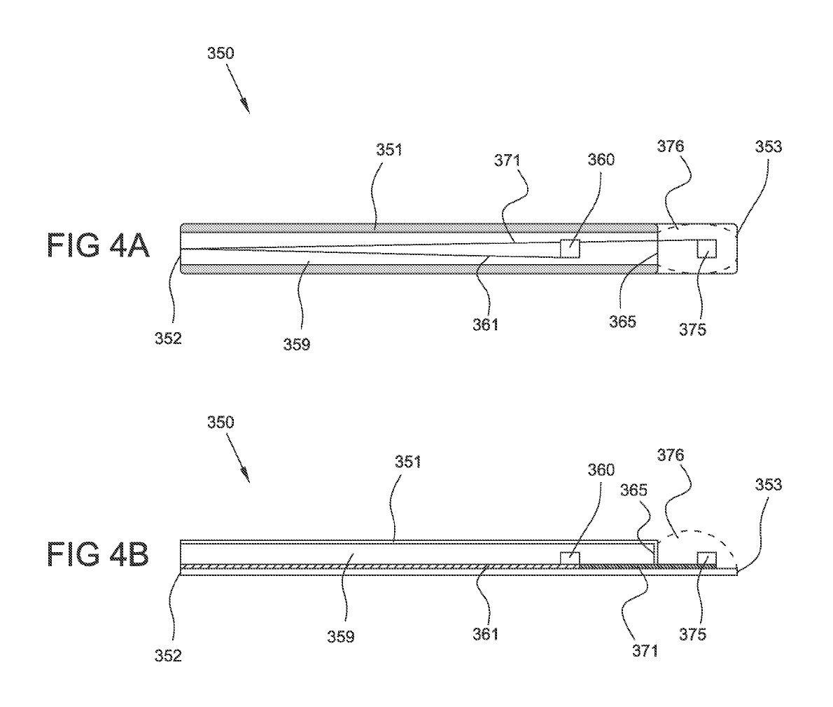

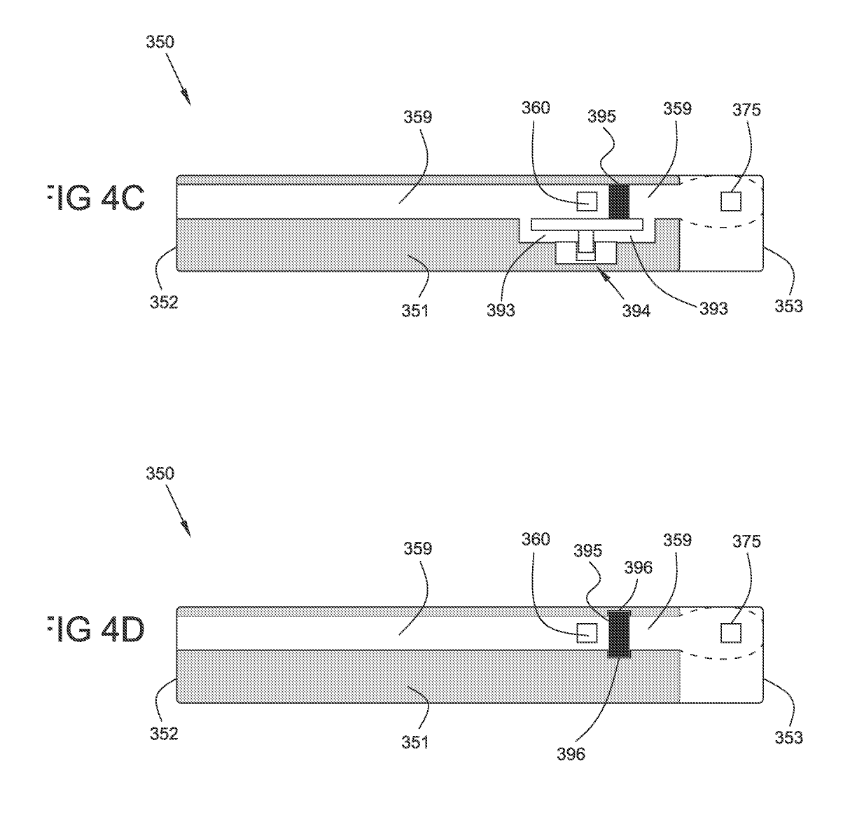

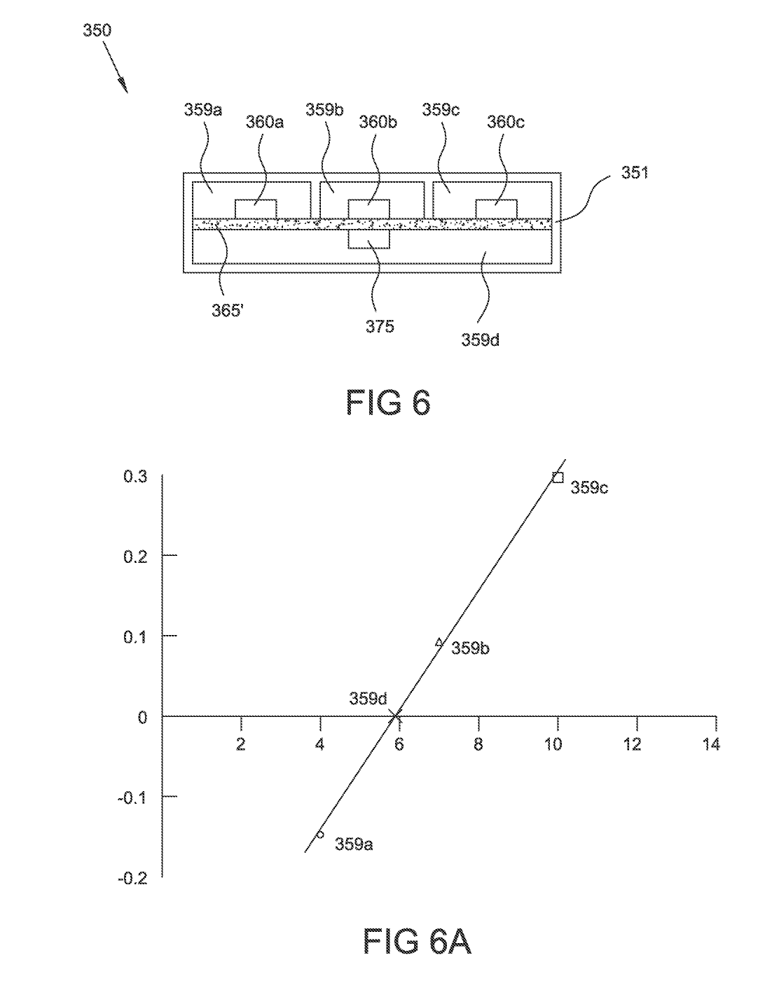

In some embodiments, channel 359 can comprise a segment with an extremely small dimension, such as a channel 359 with a segment with a width less than 1 micron, or less than 10 nanometers. This reduced width portion can be positioned between indicating electrode 375 and reference electrode 360, and configured to function as a “gate” between the indicating electrode 375 and reference electrode 360. In these embodiments, cumulative diffusion (e.g. number of ions diffused) to and/or from solution surrounding indicating electrode 375 and/or reference electrode 360 is greatly reduced, due to the reduced width portion. This reduction in cumulative diffusion allows a smaller separation distance between indicating electrode 375 and reference electrode 360 (e.g. less than 1 mm separation) without significant effects of undesired diffusion of liquid between electrodes (such as undesired diffusion of reference solution to indicating electrode 375. In addition or as an alternative to the reduced width portion, a porous membrane or other porous construction can be positioned in channel 359, such as between indicating electrode 375 and reference electrode 360, such as a permeable membrane similar to permeable liquid junction 365′ described in reference to FIG. 6 herebelow. In these embodiments, a separate flow conduit (e.g. an additional leg of channel 359) can be included to fill locations distal to the permeable membrane, such as locations surrounding indicating electrode 375. The separate flow conduit may include one or more manual or automatic valves, such as to allow occlusion or to limit flow in a single direction within the separate flow conduit. Such an alternate flow conduit including the one or more valves is described in detail in reference to FIG. 4C herebelow, and can be configured to limit flow, in at least one direction, after a calibration procedure is performed. Alternatively, the permeable membrane can be inserted into channel 359 after a calibration procedure has been performed, as is described in reference to FIG. 4D herebelow.

Housing 315 further surrounds and/or includes a supply of fluid, reservoir 322 which is operably connected to one or more fluid propulsion mechanisms, such as pump 321. Alternatively or additionally, at least a portion of a fluid supplying reservoir may be positioned in disposable probe 350, such as is described herebelow in reference to FIG. 10. Electronics module 320 is operably connected to pump 321 and is typically configured to control pump 321 to deliver fluid from reservoir 322, through port 316, and into fluidic channel 359 of probe 350. Pump 321 can be further configured to draw fluid from fluidic channel 359, into reservoir 322, such as to draw fluid from a sample solution, such as a sample solution into which the distal end 353 of probe 350 has been placed. Alternatively or additionally, reservoir 322 can be positioned in one or more portions of disposable probe 350, such as is described in reference to FIG. 10 herebelow. In these embodiments, pump 321 can be constructed and arranged to operably interface with reservoir 322, such as to cause fluid to be propelled in one or more channels of probe 350, such as fluid propelled from a reservoir, through a channel, to locations surrounding one or more electrodes. In these embodiments, pump 321 can comprise a fluid-contacting or non-fluid-contacting mechanism, such as a mechanism selected from the group consisting of: a translatable plunger or drive mechanism configured to move a plunger of probe 350; a rotating or linear peristaltic fluid drive such as a peristaltic drive configured to propel fluid in tubing of probe 350; a magnetohydrodynamic drive such as a magnetic drive configured to propel a conductive solution in probe 350; and combinations of these.

In some embodiments, housing 315 includes a second reservoir, not shown but similar to reservoir 322, such as a reservoir for collecting discarded sample solution. Fluid drawn from fluidic channel 359 can be pumped into the second reservoir such as to maintain the purity of the reference solution in reservoir 322. System 300 can include one or more reservoirs, such as reservoir 322, such as one or more reservoirs positioned within and/or insertable into reader 310, probe 350, or another component of system 300. These reservoirs can be constructed and arranged to maintain reference solution; receive reference solution; receive discarded solution; and combinations of these. In some embodiments, pump 321 comprises an electromechanical or a microfluidics pumping device selected from the group consisting of: a syringe pump; a positive displacement pump; a pneumatic pump, an electrowetting mechanism, and combinations of these. In some embodiments, pump 321 can comprise a manual pumping assembly such as a pumping assembly selected from the group consisting of: a syringe; a pipette; a micropipette; a chamber configured to be broken and/or compressed to deliver fluid; and combinations of these.

When fluidic channel 359 is filled with an electrically conductive substance (e.g. a reference solution, a sample solution, or a combination of these), the fluid within fluidic channel 359 acts as an electrical conductor, This electrical conduction completes an electrical circuit between electrodes 360 and 375 and system 300 is constructed and arranged to perform electrical measurements, such as a potentiometric measurement (i.e. measurement of the voltage difference) between indicating electrode 375 and reference electrode 360. Alternatively or additionally, an amperometric (i.e. a current) and/or a resistive measurement can be performed to determine a pH value of a sample.

Referring now to FIG. 2, a flow chart for an algorithm for calibrating a disposable sensor and reading the pH level of a sample solution is illustrated, consistent with the present inventive concepts. A system, such as is described in reference to FIGS. 1 and 1A hereabove is constructed and arranged to be automatically calibrated. The algorithm of FIG. 2 comprises STEPS 200 through 230. The components of FIGS. 1 and 1A, and their associated reference numbers are used to describe an exemplary embodiment of the algorithm of FIG. 2. In STEP 200, proximal end 352 of disposable probe 350 is inserted into port 316 of reader 310. In some embodiments, probe 350 can comprise a removably attachable distal end portion, such as is described in reference to FIG. 10 herebelow, and a distal end portion can also be attached during STEP 200.

In STEP 205, an optional step can be performed comprising one or more pre-calibration operations. The system electronics module can include one or more separate algorithms for determining system readiness conditions, including but not limited to: confirming proper engagement of probe 350 within port 316; confirming electrical connection between electrodes 360 and/or 375 with electronics module 320; recording and/or confirming a serial number of probe 350; determining the configuration of probe 350; and combinations of these.

STEP 210 comprises STEPs 210a and 210b which comprise the performance of an automated calibration of probe 350, such as an automated calibration procedure determining the sensitivity and other performance characteristics of a sensor portion of probe 350 comprising a reference electrode and an indicating electrode. STEP 210 can be initiated by the operator, such as via a user interface control of reader 310, or automatically such as at a fixed time after probe 350 is operably attached to reader 310. In STEP 210a, a reference solution is pumped from reservoir 322, such as via pump 321, into fluidic channel 359. In some embodiments, reference solution is pumped from a reservoir within reader 310, such as is described in reference to FIG. 1 hereabove. Alternatively or additionally, reference solution can be pumped from a reservoir within probe 350, such as is described in reference to FIG. 10 herebelow. The pumped reference solution is configured to cover reference electrode 360 and indicating electrode 375 completing an electrical circuit to which electronics module 320 is connected. The reference solution can be delivered in the form of one or more pre-determined volumes (e.g. boluses) of fluid into fluidic channel 359. Additionally or alternatively, fluid delivery into channel 359 can be delivered in a feedback-controlled fashion, such as fluid delivery based on measured electrode response in the presence of reference solution. In these embodiments, fluid flow can cease after the system determines a sufficient amount of reference solution has been pumped into channel 359, such as when a measured voltage exceeds a threshold.

In some embodiments, pump 321 can be used to draw a reference solution into fluidic channel 359 from an outside source, such as a source positioned at distal end 353 and used as an alternative or in addition to reservoir 322.

One or more reference solutions used can be selected from the list consisting of: a KCl solution; buffer solutions of varying chemical compositions; buffer solutions of varying pH; and combinations of these.

In STEP 210b, a calibration operation is performed, such as a single point calibration or a multiple point calibration. In some embodiments, a single point calibration is performed. The calibration is typically performed to determine the response of indicating electrode 375 with respect to reference electrode 360 in a known solution such that responses to unknown sample solutions to be measured can be properly interpreted. Differences in electrical behavior between the indicating and reference electrodes can include a difference in voltage produced when each electrode is covered by the same reference solution. The calibration performed in STEP 210b can determine this voltage difference, such as to be accounted for by module 320 in one or more subsequent steps such as the determining of the pH of a sample solution performed in STEP 225 herebelow. In some embodiments, electrodes 360 and 375 are IrOx electrodes. IrOx electrodes produce an electric potential between a solution and the surface of the electrode, such as can be described by Eq. 1:

Vᵢ=mᵢ*pH+bᵢ

where V is the measured voltage, pH is the actual pH of the solution, m is the sensitivity of the electrode, b is an offset voltage, and the subscript i represents the specific electrode. Typically, the sensitivity m is assumed to be constant for each of the electrodes, such as indicating electrode 375 and reference electrode 360. The offset voltage b is determined by the calibration operation.

In use, the pH value is determined by measuring the voltage difference between two electrodes; a reference electrode in a known buffer solution, pH_{ref}; and an indicating electrode in a sample solution, pHₜₑₛₜ. The equation for this measurement is shown in Eq. 2:

V_{ref}−V_{ind}=m_{ref}*pH_{ref}−m_{ind}pHₜₑₛₜ+b_{ref}−b_{ind}

where V_{ref} and V_{ind}, m_{ref} and m_{ind}, and b_{ref} and b_{ind} are the potentials, sensitivities, and offsets for the reference and indicating electrodes, respectively. pH_{ref} is the actual pH of the reference solution, and pHₜₑₛₜ is the pH of the test solution. In a single measurement, V_{ref}−V_{ind}=V is measured, so Eq. 2 can be rewritten as Eq. 3:

V=m_{ref}*pH_{ref}−m_{ind}*pHₜₑₛₜ+b_{ref}−b_{ind}

For single-point calibration, we assume that m_{ref}=m_{ind}=m so Eq. 3 can be rewritten as Eq. 4:

V=m*pH_{ref}−m*pHₜₑₛₜ+b_{ref}−b_{ind}

During calibration both electrodes are covered with reference solution, so pH_{ref}=pHₜₑₛₜ and is a known value, so the sensor can be calibrated to find the difference between b_{ref} and b_{ind}, defined as b=b_{ref}−b_{ind}. In STEP 225 of FIG. 2, the measurement of sample solution pH is made by removing the reference solution from the indicating electrode 375 (either by dipping the exposed indicating electrode 375 into the sample solution or drawing the sample solution into the channel to cover the indicating electrode 375 as described above) and a new voltage difference is measured between indicating electrode 375 and reference electrode 360. This new voltage difference can be written as Eq 5:

V=m*pH_{ref}−m*pHₜₑₛₜ+b

where the value, b, was determined in the single point calibration step. The unknown value, pHₜₑₛₜ, can be determined by electronics module 320 in STEPS 220 and 225 of FIG. 2, as described below.

In STEP 220, sample solution is placed in contact with indicating electrode 375. In some embodiments, distal end 353 of probe 350 is placed into the sample solution to be tested. Pump 321 draws sample solution into fluidic channel 359, such as to cover indicating electrode 375. Within fluidic channel 359 and at a location between reference electrode 360 and indicating electrode 375, the reference solution contacts the sample solution. In some embodiments, fluidic channel 359 is constructed and arranged to minimize or prevent mixing of the sample and reference solutions within channel 359, such as by limiting the cross sectional area, controlling the flow rate and/or by including a permeable membrane configured to prevent undesired diffusion. In STEP 225, the pH of the sample is determined. In some embodiments, electronics module 320 measures the voltage difference between the indicating electrode 375 and reference electrode 360. This voltage difference is converted to pH using Eq. 5, repeated here:

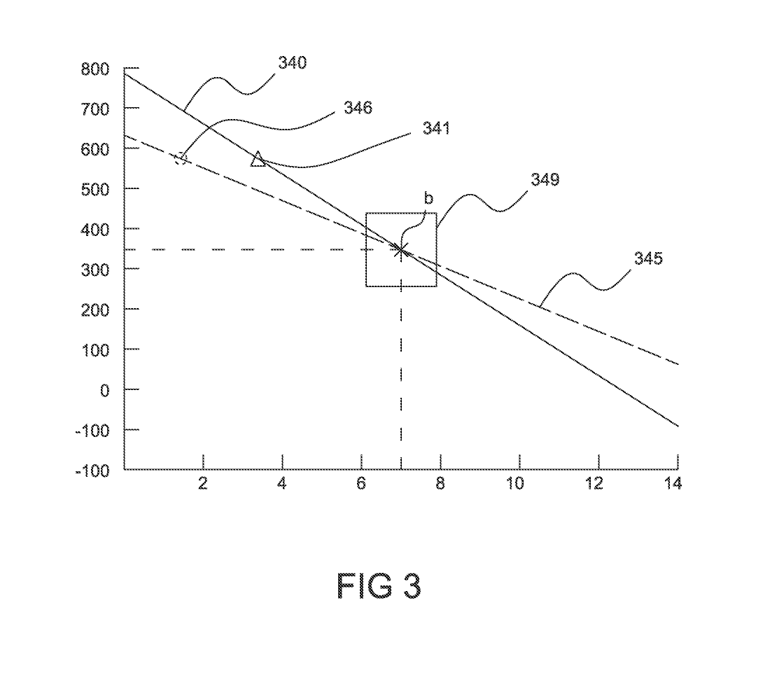

V=m*pH_{ref}−m*pHₜₑₛₜ+b

where pH_{ref} is known because the reference solution is still covering the reference electrode 360, m is assumed to be known from manufacture, b is known from the one-point calibration in STEP 210, and V is measured, so pHₜₑₛₜ can be calculated. Likewise, a calibration curve, as discussed in detail in reference to FIG. 3 herebelow, with the pH value typically provided in numeric or alphanumeric form on display 313.

In STEP 230, after pH has been measured, probe 350 is removed from reader 310 and disposed of, such that a new probe 350 can be used to make a subsequent reading. In an alternative embodiment, probe 350 can be constructed and arranged for multiple pH measurements, such as multiple measurements which are limited by system 300 (e.g. less than 10 measurements per probe 350). Multiple measurements can comprise multiple calibration steps, such as by performing STEP 210 multiple times, such as multiple similar or dissimilar calibration procedures. Multiple measurements can be performed by replacing a portion of probe 350, such as by replacing a tip portion of probe 350 such as is described in reference to FIG. 10 herebelow.

Referring now to FIG. 3, a graph of a calibration curve is illustrated, consistent with the present inventive concepts. A predicted relationship between measured potential difference of the indicating and reference electrodes is shown by line 340. Line 340 relates measured voltages, such as voltages measured by an electronics module, to pH values of a solution being measured. Slope, m_{predicted}, of line 340 represents a predicted sensitivity of the indicating electrode. Sensitivity m is assumed to be constant for the duration of the measurement, and equal in value to that of electrodes tested during manufacture. A calibration process, such as a calibration process described in reference to FIG. 2 hereabove, can be performed to determine an offset, b, of line 340. Offset b is determined by measuring the potential difference between the indicating and reference electrode in a known pH solution, and line 340 is offset such that line 340 passes though point b.

Line 345 represents the actual relationship between voltage and pH value for an individual pH sensor, having slope, m_{actual}. Variations in the sensitivity result in variations in pH readings taken using a pH sensor, such as the pH sensors described herein. In some embodiments, acceptable ranges in pH measurement accuracy include acceptable variations, represented by region 349. Point 341 represents a possible measurement taken using a pH sensor. Point 341 shows a voltage reading of ˜600 mV, which correlates to a pH of ˜3.7 when using an assumed value for the sensitivity of the sensor, m_{predicted}. Point 346 shows a voltage reading equal to the voltage reading at point 341, but correlating to an actual pH of ˜1.8, using the actual, yet unknown, sensitivity of the sensor, m_{actual}.

Due to inaccuracy caused by this unknown sensor sensitivity, measurements performed on a sample solution with a pH approximating that of the reference calibration solution, have less inherent error. In the embodiment shown in FIG. 3, the reference solution has a pH of 7.0, and improved results are achieved when the sample solution has a pH approximating 7.0, such as a sample solution with a pH between 6.0 and 8.0 as shown, which reduces the error caused by the difference between m_{predicted} and m_{actual}. In some embodiments, system 300 can be configured and arranged to calibrate a sensor, perform a pH reading, and then recalibrate the sensor with a reference solution approximating the measured pH of the sample solution. A second measurement can then be taken of the sample solution, providing a reading with less possible error.

In some embodiments, the calibration can include two or more reference solutions, such that both offset b and slope m_{actual} can be determined.

Referring now to FIGS. 4A and 4B, top and side views, respectively, of a disposable probe comprising an indicating electrode outside of a fluidic channel is illustrated, consistent with the present inventive concepts. Probe 350 comprises housing 351 having proximal end 352 and distal end 353. Fluidic channel 359 extends from proximal end 352 to a point proximal to distal end 353. Probe 350 further comprises reference electrode 360, indicating electrode 375, and wires 361 and 371. Wire 361 and/or wire 371 can each include one or more electrical wires or one or more distinct electric pathways, such as one or more wires or electrically conductive pathways surrounded by an insulator. Wire 361 and/or wire 371 can comprise one or more electrical traces, such as one or more electrical traces separated by air or other insulating material to prevent shorting. Reference electrode 360 is positioned within fluidic channel 359, such that fluid transported through channel 359 contacts reference electrode 360. Indicating electrode 375, positioned proximate distal end 353 of probe 350, is positioned outside of fluidic channel 359, such that fluid contact between indicating electrode 375 and a sample solution is not caused by the flow of fluid through fluidic channel 359. Indicating electrode 375 is placed in contact with sample solution when distal end 353 is placed into a sample solution and/or when sample solution is delivered to distal end 353.

Probe 350 is configured to operably connect to a reusable reader, such as reader 310 of FIG. 1. During a calibration procedure, such as the calibration procedure described in reference to FIG. 2 hereabove, probe 350 is configured to surround indicating electrode 375 with reference solution in the form of droplet 376, such as by delivering (e.g. pumping) reference solution from the proximal end of probe 350 (e.g. from a reservoir in a reader), from a reservoir in probe 350 (not shown but described in reference to FIG. 10 herebelow), and/or by delivering reference solution from the distal end of probe 350. Droplet 376 forms an electrical connection between electrodes 360 and 375, such that probe 350 can be calibrated as described hereabove. After a calibration procedure has been performed, droplet 376 is displaced by sample solution, such as when distal end 353 of probe 350 is placed into sample solution. A junction, liquid junction 365 is formed between the reference solution in channel 359 and the sample solution. Liquid junction 365 maintains an electrical connection between electrodes 360 and 375 via the reference solution in fluidic channel 359 and sample solution proximate the distal end of fluidic channel 359, such as is described in reference to U.S. patent application Ser. No. 13/510,450, titled “pH Sensor”, filed May 17, 2012 and incorporated herein by reference in its entirety. In the embodiments of FIGS. 4A and 4B, continuous measurement of the pH of a sample solution can be taken, as indicating electrode 375 is in continuous contact with the sample during the measurement. In some embodiments, an extended test time and/or degradation prevention procedure can be performed, such as to prevent degradation of the reference solution by diffusion of sample solution toward indicating electrode 375. In these embodiments, additional reference solution can be pumped through channel 359 (moving diffused sample solution away from reference electrode 360). Liquid junction 365 is re-established by reapplying a sample solution droplet or by reinserting indicating electrode 375 into sample solution. This procedure or other extended test time and/or degradation preventing procedures can be performed a single or multiple times, such as multiple procedures performed at pre-determined time intervals.

Referring now to FIG. 4C, a top view of a disposable pH sensing probe including a permeable membrane and a flow diverting channel is illustrated, consistent with the present inventive concepts a top view of a disposable probe. Probe 350 of FIG. 4C can include componentry similar to probe 350 of FIGS. 4A and 4B, such as housing 351 with proximal end 352 and distal end 353; reference electrode 360; indicating electrode 375; and channel 359. Probe 350 of FIG. 4C further includes a permeable membrane 395 positioned between reference electrode 360 and indicating electrode 375 in channel 359. Permeable membrane 395 can be configured to minimize undesired diffusion of fluid between reference electrode 360 and indicating electrode 375, such as undesired diffusion of reference solution from reference electrode 360 to indicating electrode 375 and/or undesired diffusion of one or more fluids from indicating electrode 375 to reference electrode 360. Permeable membrane 395 can be rigid or flexible, or it can contain both rigid and flexible portions. Permeable membrane 395 can be thin or thick, and it may comprise materials selected from the group consisting of: Teflon; ceramic; glass; polyethylene; and combinations of these. Permeable membrane 395 can be configured to allow electrical connection between liquids on either side of permeable membrane 395. Permeable membrane 395 can be configured to act as the liquid junction, or be at a location proximate the liquid junction. In order to rapidly wet indicating electrode 375 with reference solution for calibration without requiring the reference solution to pass through permeable membrane 395, probe 350 further includes a flow diverting channel, alternative pathway 393. Valve assembly 394 is mounted to housing 351 and positioned to selectively occlude flow within alternative pathway 393. Valve assembly 394 is shown in the closed position in FIG. 4C, such as to prevent flow through pathway 393. During a priming and calibration procedure, valve assembly 394 is opened, allowing reference solution to pass through pathway 393 and fully prime channel 359 including the area surrounding reference electrode 360 and indicating electrode 375. After priming and/or one or more calibration procedures, valve assembly 394 is closed, limiting flow between reference electrode 360 and indicating electrode 375 to travel through permeable membrane 395. Valve assembly 394 can comprise a solenoid-driven piston which occludes pathway 393, such as a solenoid driven by one or more wires, not shown but traveling proximally to control circuitry of an attached reader such as reader 310 of FIG. 1. Alternatively, valve assembly 394 can comprise a one-way valve, such as a duck-bill valve oriented to allow fluid flow in pathway 393 in one direction, to the right of the page as shown in FIG. 4C. Valve assembly 394 may comprise a mechanical or electro-mechanical valve assembly. Valve assembly 394 may be manually activated by an operator or it may be automatically operated, such as via an attached reader after a calibration or other procedure is complete.

Referring now to FIG. 4D, a top view of a disposable pH sensing probe including an operator insertable permeable membrane is illustrated, consistent with the present inventive concepts. Probe 350 of FIG. 4D can include componentry similar to probe 350 of FIGS. 4A and 4B, such as housing 351 with proximal end 352 and distal end 353; reference electrode 360; indicating electrode 375; and channel 359. Probe 350 of FIG. 4C further includes a permeable membrane 395, shown having been inserted by an operator into slot 396, at a location between reference electrode 360 and indicating electrode 375 in channel 359. Permeable membrane 395 can be configured to minimize undesired diffusion of fluid between reference electrode 360 and indicating electrode 375, such as undesired diffusion of reference solution from electrode 360 to indicating electrode 375. In order to rapidly prime probe 350, permeable membrane 395 is removed or not yet present in slot 396, allowing reference solution to pass through channel 359 including the areas surrounding reference electrode 360 and indicating electrode 375. After priming and/or one or more calibration procedures, permeable membrane 395 is inserted into slot 396, causing flow between reference electrode and indicating electrode 375 to pass through permeable membrane 395. In an alternative embodiment, permeable membrane 395 remains in place during use, and is configured as a one-way valve which allows flow of fluid in a single direction (e.g. to allow priming) while preventing flow in the opposite direction (e.g. to prevent undesired diffusion of fluids). The one-way valve construction of permeable membrane 395 can comprise a duck-bill valve or a valve which can fold or otherwise distort when fluid force is applied from a first direction while maintaining its shape when a fluid force is applied from the opposite direction.

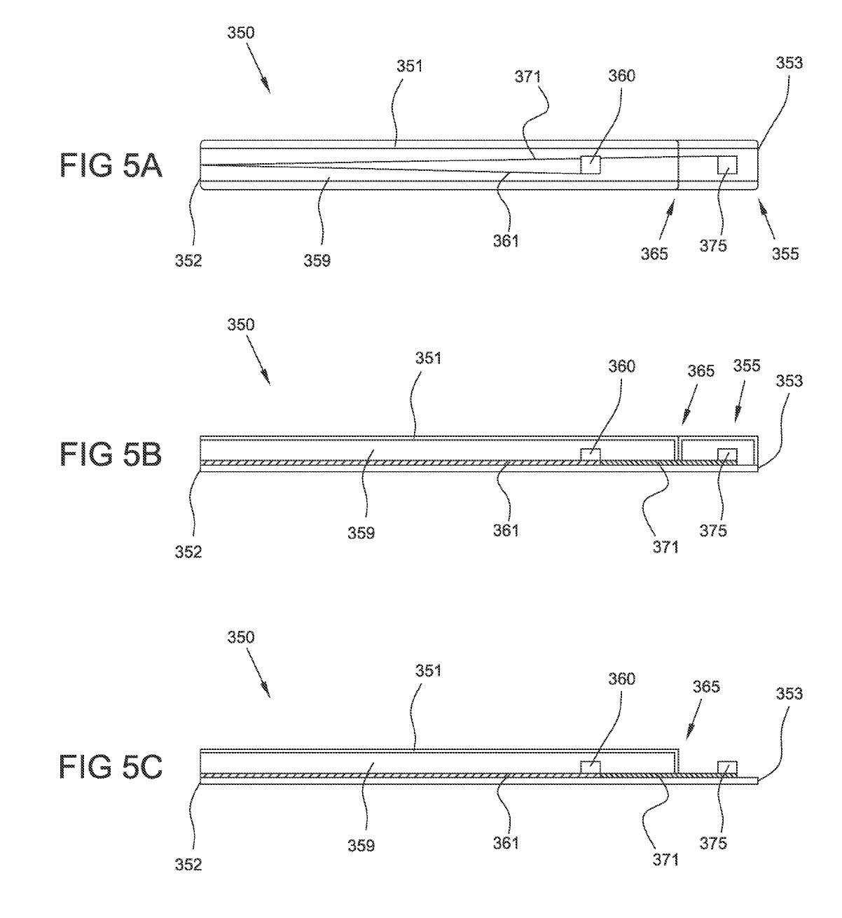

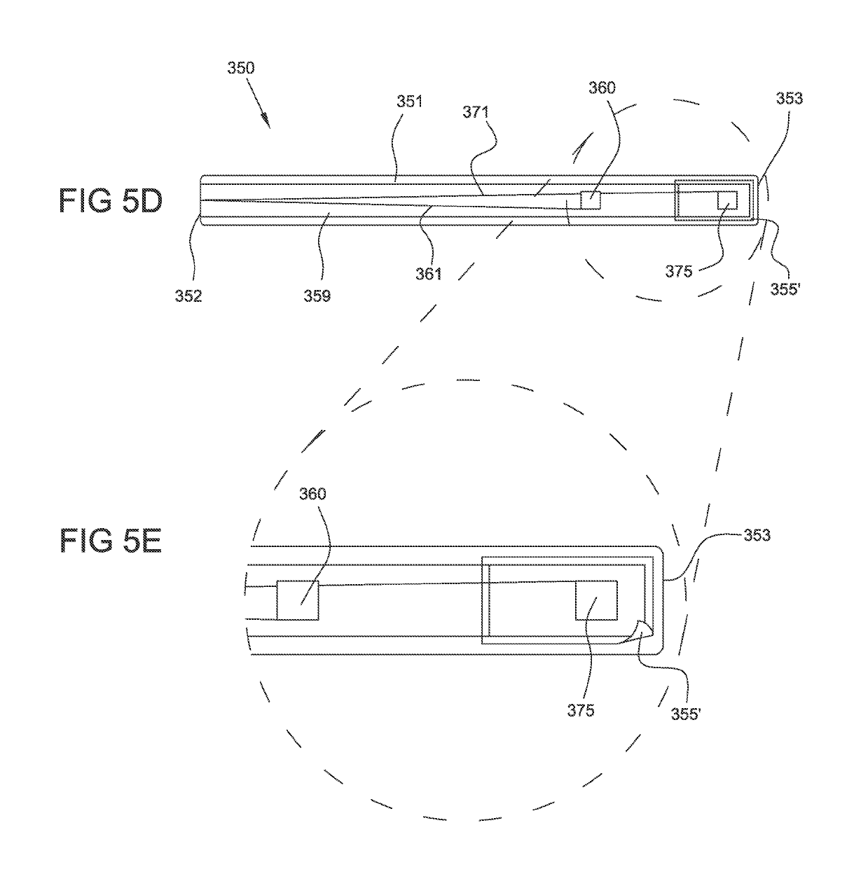

Referring now to FIGS. 5A and 5B, top and side views, respectively, of a disposable probe comprising a fluidic channel with a removable distal cover are illustrated, consistent with the present inventive concepts. Probe 350 comprises components similarly configured to probe 350 of FIGS. 4A and 4B hereabove, with similar reference numbers used. Housing 351 covers fluidic channel 359 and includes a removable distal portion, cap 355. Reference electrode 360 is positioned within fluidic channel 359, proximal to cap 355. Indicating electrode 375, positioned proximate distal end 353 of probe 350, is also positioned within a portion of the fluidic channel 359. With cap 355 in place, a calibration procedure, such as the calibration procedure described in reference to FIG. 2 hereabove, can be performed. The calibration can include pumping reference solution into fluidic channel 359, including a channel portion defined by cap 355, such that the reference solution covers electrodes 360 and 375 during the calibration.

Referring now to FIG. 5C, cap 355 has been removed, such as after a calibration procedure has been performed, terminating channel 359 proximal to indicating electrode 375 and enabling indicating electrode 375 to be directly exposed to test samples. Similar to the embodiment of FIGS. 4A and 4B, probe 350 is constructed and arranged such that continuous measurement of the pH of a sample solution can be taken, such as when the distal end of probe 350, comprising the newly exposed indicating electrode 375, is placed in a sample solution. In these embodiments, liquid junction 365 is formed between a reference solution filling fluidic channel 359 and a sample solution in which the distal tip of probe 350 is submerged. At this time a measurement device, such as reader 310 described in reference to FIG. 1 hereabove, performs a pH measurement.

Referring now to FIGS. 5D and 5E, top and expanded top views, respectively, of a disposable probe comprising a fluidic channel with a removable distal cover are illustrated, consistent with the present inventive concepts. Probe 350 includes fluidic channel 359, as has been described in detail hereabove. Distal end 353 of probe 350 can include an opening in fluidic channel 359, such as to expose at least a portion of indicating electrode 375. Probe 350 further comprises covering 355′, configured to seal the opening in fluidic channel 359, covering indicating electrode 375 (e.g. via the use of one or more adhesives sealing cover 355′ around one or more openings of channel 359). In some embodiments, probe 350 can be pre-filled with a reference solution, such as a reference solution used in a calibration procedure, such as a calibration procedure described herein. Covering 355′ can be configured to be removed, such as by being peeled off of probe 350, exposing indicating electrode 375, within fluidic channel 359. In some embodiments, covering 355′ can include one or more openings sized and positioned to expose one or more portions of indicating electrode 375 (e.g. the top and/or a side portion of indicating electrode 375), such that indicating electrode 375 is partially within channel 359 and partially exposed. In some embodiments, probe 350 can be stored and/or packaged in a dry state (e.g. no reference solution or other liquid in contact with channel 359 and/or reference electrode 360), with reference solution delivered prior to use. A calibration procedure, including filling fluidic channel 359 with a reference solution, can be performed, such as after covering 355′ has been removed and probe 350 has been inserted into a reusable reader.

Referring now to FIG. 6, an end view of a disposable probe comprising multiple fluidic channels, multiple reference electrodes, and a permeable liquid junction is illustrated, consistent with the present inventive concepts. Probe 350 comprises housing 351. Housing 351 comprises fluidic channels 359a, 359b, 359c, and 359d. Probe 350 further comprises reference electrodes 360a, 360b, 360c, positioned in fluidic channels 359a, 359b, 359c, respectively. Probe 350 further comprises indicating electrode 375 positioned within fluidic channel 359d. Probe 350 further comprises permeable liquid junction 365′, typically a permeable membrane constructed and arranged to provide a conductive fluid-based electrical connection between reference electrodes 359a-359c and indicating electrode 359d. Liquid junction 365′ and/or housing 351 can be further constructed and arranged to minimize or prevent mixing of solutions between channels 359a-359d, such as by limiting its porosity as has been described above in reference to permeable membrane 395 as described in reference to FIGS. 4C and 4D hereabove. Fluidic channels 359a-359c can be filled with reference solutions, such as via a fluid port of a reader, such as reader 310 of FIG. 1. The reader can be constructed and arranged to comprise multiple reference solution reservoirs, such as reservoirs or solutions with different pH values, and can be further constructed and arranged to operably attach to probe 350 such that channels 359a-359c can be filled with these solutions. In some embodiments, a reader or other fluid delivery device can be configured to selectively deliver one or more similar or different reference solutions to one or more of channels 359a-359c.

Referring now to FIG. 6A, a graph of multiple measured voltages used to determine pH of a solution is illustrated, consistent with the present inventive concepts. Probe 350 of FIG. 6 can be constructed and arranged such that channels 359a-359c are each filled with reference solutions of a different pH level. In the embodiments shown in FIG. 6A, channel 359a comprises a reference solution with a pH of approximately 4, channel 359b comprises a reference solution with a pH of approximately 7, and channel 359c comprises a reference solution with a pH of approximately 10. Indicating electrode 375 is exposed to sample solution, such as by drawing sample solution into channel 359d by one or more pumping mechanisms as described in reference to FIG. 1 hereabove. Alternatively or additionally, indicating electrode 375 is exposed directly to sample solution such as is described in reference to FIGS. 4A and 4B or as is described in reference to FIGS. 5A-5C hereabove. The potential difference between indicating electrode 375 exposed to a sample solution, and reference electrodes 359a, 359b and 359c exposed to a buffer solutions with a pH of approximately 4, 7 and 10 respectively is plotted as shown in the graph of FIG. 6A. An attached reader and associated electronics, such as reader 310 and electronics module 320 of FIG. 1 described hereabove, can include a “best fit” algorithm, such as to determine a best fit line between the multiple data points plotted in the graph, such as a “best fit” algorithm known to those skilled in the art. In these embodiments, the zero crossing of said best fit line is equated to the pH of the sample solution. In some embodiments, the probe 350 of FIG. 6 can be calibrated, such as with one or more calibration methods described herein.

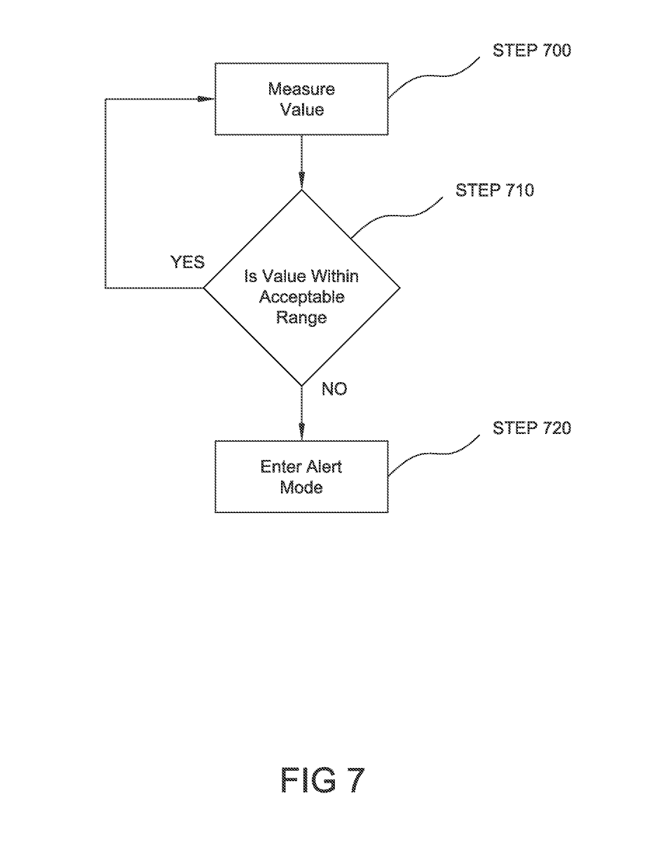

Referring now to FIG. 7, a flow chart for an error detection algorithm for a system configured to measure the pH of a sample is illustrated, consistent with the present inventive concepts. In STEP 700, a value is measured, such as a measured voltage. Measured voltages include but are not limited to a potential difference between an indicating electrode and a reference electrode such as when each are exposed to a reference solution or when the reference electrode is exposed to a reference solution and the indicating electrode is exposed to a sample solution. Alternatively or additionally, measured values can include the value of a parameter selected from the group consisting of: a temperature; a pressure; a current; a resistance; presence or strength of a magnetic field; and combinations of these.

In STEP 710, the measured value is compared to a threshold (e.g. a pre-determined value) configured to determine if the measured value is acceptable, such as a measured value at a level that is acceptable at the particular time of measurement. If the measured value is determined to be acceptable, the algorithm is complete or STEP 700 can be repeated, as is shown in FIG. 7. Repeating of STEPs 700 and/or 710 can be performed on a continual basis or intermittently at regular or irregular time intervals.

If the comparison performed in STEP 710 is unacceptable, STEP 720 is performed in which an alert mode is entered. The alert mode can cause a pH sensing system of the present invention to notify a user, such as via an audible alert and/or via information displayed on a user interface, such as the user interface of system 300 of FIG. 1 described hereabove. In some embodiments, continued measurements are prevented after the alert mode is entered. In other embodiments, one or more maintenance procedures and/or repeated tests are performed prior to additional measurements being performed.

Referring now to FIG. 8, a perspective view of a disposable pH sensing probe portion and reusable access port is illustrated, consistent with the present inventive concepts. Access port 330 is constructed to slidingly receive, and operably engage probe portion 450. Access port 330 can comprise an integral attachment port of a reader, such as electromechanical port 316 of reader 310 of FIG. 1 described hereabove. Alternatively, access port 330 can comprise a multiple-use proximal portion of a probe (e.g. probe 350 of FIG. 1). In these embodiments, the probe, including access port 330 and a single use distal portion such as probe portion 450, can be inserted as an assembly into a separate attachment port integral to a reusable reader (e.g. port 316 of reader 310 of FIG. 1). Systems comprising a reader and these two piece probes are described in detail in reference to FIG. 10 herebelow. Access port 330 comprises housing 331 which surrounds opening 332. Opening 332 is configured to slidingly receive probe portion 450, such as to electrically, mechanically and/or fluidly connect to one or more components of probe portion 450. In some embodiments, probe portion 450 can include locking features, such as a snap lock feature, not shown but typically configured as follows. Locking features can be configured to fixedly secure probe portion 450 into access port 330. Locking features can be further configured to be operably released, such as by the overcoming of a force, or by a release mechanism configured to release probe portion 450 from access port 330.

Access port 330 includes a puncturing element, needle 335 as well as electrical contacts 334. Probe portion 450 includes multiple components of similar construction and arrangement as probe 350 of FIGS. 1, 4A, 5A and/or 6. Probe 450 comprises housing 351, including distal end 353. Probe portion 450 further includes indicating electrode 375, reference electrode 360, fluidic channel 359, and wires 361 and 371. Fluidic channel 359 comprises fluidic chamber 358, positioned at the proximal end of probe 350 as shown. Wires 361 and 371 terminate in connecting pads 362 and 372, respectively.

Connecting pads 362 and 372 are configured to engage electrical contacts 334 of access port 330, such as to provide electrical communication between indicating electrode 375 and reference electrode 360, and one or more electrical components connected to access port 330, such as electronics module 320 of reader 310 of FIG. 1 described hereabove.

Needle 335 is configured to puncture fluidic chamber 358 and to provide fluid communication between fluidic channel 359 and components connected to access port 330, such as reservoir 322 of reader 310 of FIG. 1 described hereabove. FIG. 8A illustrates probe 350 having been operably inserted into access port 330, such that the distal end of needle 335 is positioned within fluidic chamber 358. In some embodiments, fluidic chamber 358 contains one or more reference solutions, such as reference solution caused to be propelled through channel 359 and to surround reference electrodes 360 and/or indicating electrode 375. Fluid propulsion can be achieved via one or more pumping elements of an attached reader, such as is described in reference to FIGS. 1 and 10 herein.

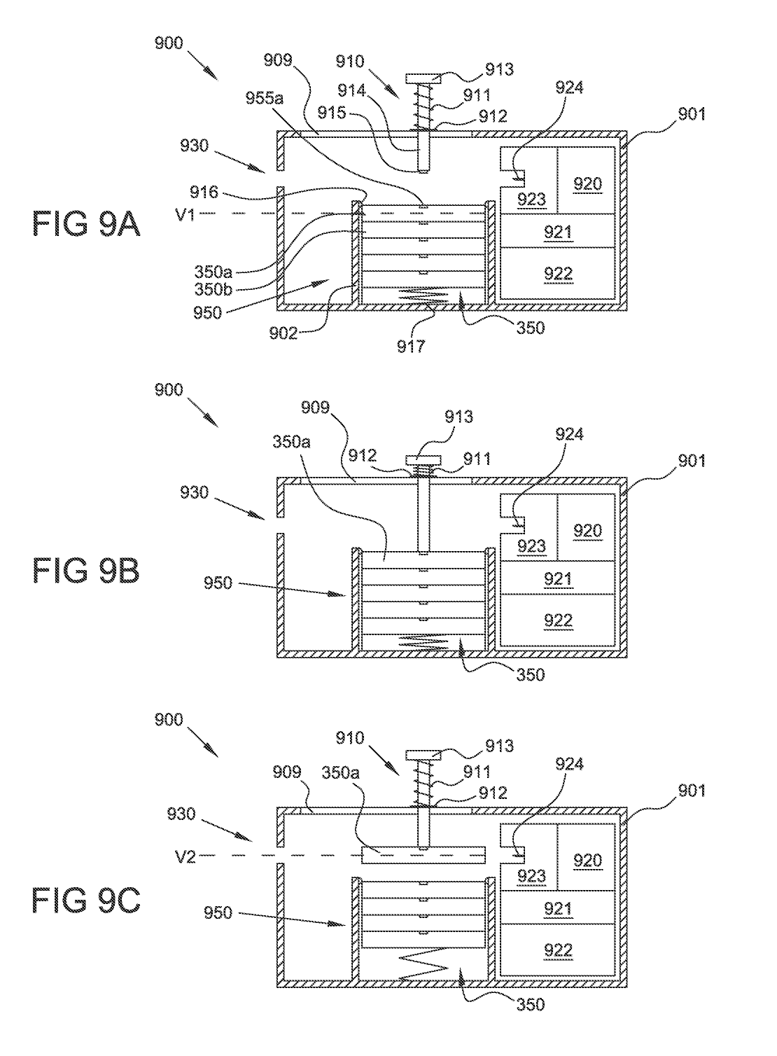

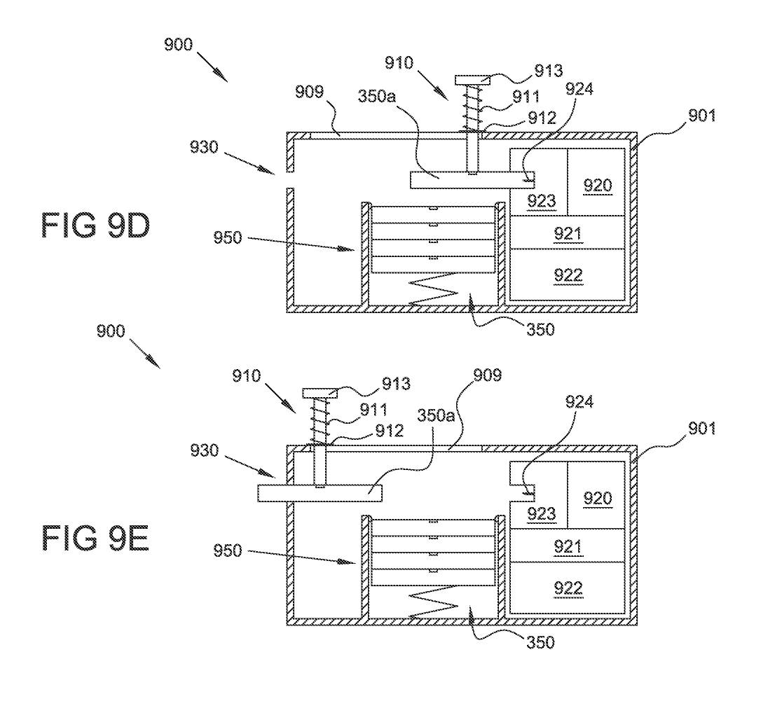

Referring now to FIGS. 9A-9E, a sectional view of a pH sensing probe dispenser is illustrated in multiple steps of operation, consistent with the present inventive concepts. Dispenser 900 comprises housing 901, capture assembly 910, storage assembly 950, and exit port 930. Storage assembly 950 comprises walls 902 which extend from housing 901 and are configured to at least partially surround and maintain the position of multiple probes 350, such as probe 350a and 350b. Probes 350 can be constructed and arranged to be operably engaged with a reader for obtaining a pH measurement, such as is described in reference to FIG. 1 hereabove. Storage assembly 950 includes spring 917 which applies a force to the bottom-most probe 350, in an upward direction as shown in the illustrations, such that each probe 350 receives an associated upward force. Storage assembly 950 further includes one or more protrusions, such as protrusions 916 constructed and arranged to temporarily limit movement of the top-most probe 350, such as to maintain the top-most probe 350 (probe 350a) at vertical position V1 as shown. Protrusions 916 are configured to maintain the top-most probe 350a at position V1 while the vertical force is applied by spring 917. In some embodiments, protrusions 916 comprise a continuous ring of material extending from walls 902. Protrusions 916 are further configured to allow the top-most probe 350a to vertically translate when an additional force is applied, such as the force applied by capture assembly 910.

Capture assembly 910 includes shaft 914, cap 913, spring 911, washer 912, and a capture element, tip 915. Spring 911 is configured to create a biasing force, to maintain the position of tip 915 as described herebelow. Housing 901 comprises slot 909, a vertical elongate recess in housing 901 configured to slidingly engage shaft 914 of capture assembly 910. Tip 915 is configured to operably engage a capture port of one or more probes 350, one at a time, such as by tip 915 engaging capture port 955a of probe 350a as described in detail herebelow. In some embodiments, tip 915 and capture port 955a can comprise mating threaded components (e.g. an inside thread in capture port 955a is engaged by an outside thread of tip 915). In these embodiments, an operator can rotate cap 913 to cause shaft 914 and tip 915 to rotate, such as to rotatably engage tip 915 with capture port 955a. Additionally or alternatively, tip 915 and a probe 350 capture port (e.g. capture port 955a) can comprise component pairs selected from the group consisting of: magnetic coupling components; snap fit coupling components; frictionally engaging components; hook and loop coupling components, such as Velcro; and combinations of these.

Dispenser 900 further includes electronics module 920, pumping mechanism 921, reservoir 922 and access port 923. Access port 923 comprises needle 924, typically a hollow needle configured to provide fluid access to a puncturable interface. Electronics module 920 typically comprises one or more electronic components such as components selected from the group consisting of: analog circuitry; digital circuitry; a power supply such as a battery or capacitor, software; algorithms; one or more microcontrollers; and combinations of these. Reservoir 922 comprises one or more chambers configured to store one or more fluids, such as one or more reference solutions. Pumping mechanism 921 comprises a pump assembly, such as a pump assembly configured to propel one or more fluids, such as one or more fluids contained within one or more chambers of reservoir 922. Pump mechanism 921 can be configured to propel one or more fluids from reservoir 922 to access port 923, such as is described below.

Referring now to FIG. 9B, cap 913 has been depressed, compressing spring 911 and causing tip 915 to engage with capture port 955a. In some embodiments, a further action, such as rotation described hereabove, can be used to complete the engagement between tip 915 and capture port 955a.

Referring now to FIG. 9C, cap 913 has been allowed to translate vertically, manually and/or due to the force of spring 911, to its starting position, wherein probe 350a is at vertical position V2, as shown. Probe 350a has translated vertically due to the attachment of capture port 955a with tip 915. When a probe 350 is vertically positioned at V2, it is horizontally aligned to mate with access port 923, such as when horizontally translated by an operator sliding cap 913 to the right of the page as shown. Also when positioned at V2, a probe 350 is horizontally aligned to pass through exit port 930, such as when horizontally translated by an operator sliding cap 913 to the left of the page as shown.

Referring now to FIG. 9D, cap 913 has been translated to the right of the page such that the right end of probe 350a operably engages access port 923, such as a fluid, electrical and/or mechanical engagement with access port 923. Numerous operations can be performed upon probe 350a, such as one or more operations selected from the group consisting of: delivery of a reference solution to probe 350a such as a reference solution propelled from reservoir 922 by pump 921; a calibration procedure such as the calibration procedure described in reference to FIG. 2 hereabove; a voltage treatment such as a voltage treatment applied to probe 350a by electronics module 920; an activation procedure such as a procedure performed to prepare probe 350a for pH measurement; and combinations of these. These operations can be of short duration, such as less than 30 seconds or less than 5 minutes, or they can require a longer time period, such as greater than 15 minutes or greater than 1 hour.

Referring now to FIG. 9E, cap 913 has been translated to the left of the page such that the left end of probe 350a has passed through exit port 930. At this position, probe 350a can be operably attached to a reader, such as reader 310 of FIG. 1 described hereabove. Prior to, during or after attachment to a reader, probe 350 can be fully removed from dispenser 900, such as to be brought into contact with a sample solution to be tested.

Time periods between the various steps illustrated in FIGS. 9A through 9E can be of short duration or long duration. In some embodiments, probe 350a is engaged with access port 923, as shown in FIG. 9D, for a significant period of time, prior to being translated to the left to pass through exit port 930 as shown in FIG. 9E. Probe 350a can remain engaged with access port 923 for a period of time to allow one or more operations, such as a calibration or voltage treatment operation, to occur. Alternatively or additionally, probe 350a can remain engaged with access port 923 during a storage period.

Referring now to FIG. 10, a top view of a pH measurement system including a reusable reader and a two-piece insertable probe is illustrated; consistent with the present inventive concepts. The insertable probe comprises a multiple use proximal portion and a single use distal portion. System 300 includes reader 310 and probe 350. Reader 310 can be of similar construction to reader 310 of FIG. 1 described hereabove. Reader 310 includes user interface 311 which includes buttons 312 and display 313, mounted to housing 315. Reader 310 includes an input port 316, operably connected to various components internal to housing 315 such as an electronics module, one or more pumps or pumping mechanisms, and other components and assemblies configured to operably interface with one or more components or assemblies of probe 350.

Probe 350 comprises a multiple use component, proximal probe portion 330, which is configured to operably engage with a single use component, distal probe portion 450. Proximal probe portion 330 and distal probe portion 450, respectively, can be of similar construction and arrangement as input port 330 and distal probe portion 450 of FIGS. 8 and 8A. Proximal probe portion 330 includes a proximal end 352. A reservoir 422 is positioned on or within probe portion 330 and is proximate a pump assembly 421. Reservoir 422 may include one or more chambers, such as one or more chambers each surrounding one or more supplied of reference solution. Pump assembly 421 can comprise one or more pumping mechanisms, such as those described herein, and can be configured to be operably controlled by one or more drive elements of reader 310, such as when probe 350 is inserted into reader 310. Reservoir 422 is in fluid communication with fluidic channel 359′ of probe portion 330. A projecting connector 435, also in fluid communication with channel 359′, is positioned at the distal end of probe portion 330.

Distal probe portion 450 includes receiving connector 436, which is sized and configured to operably engage with projecting connector 435 of proximal probe portion 330. When attached, projecting connector 435 and receiving connector 436 allow transfer of fluids, electrical signals, electrical power, optical signals and/or optical power between proximal probe portion 330 and distal probe portion 450, in either direction. For example, wires, not shown but such as is described in detail hereabove, can be included to electrically connect reference electrode 360 and/or indicating electrode 375 to proximal probe portion 330 and eventually an electronics module of reader 310, such as to perform voltage or other measurements used to determine pH of a sample solution. In an alternative embodiment, distal probe portion 450 includes a projection, such projecting connector 435 and proximal probe portion 330 includes a receiving element for the projection, such as receiving connector 436.

Distal probe portion 450 includes fluidic channel 359″, which is fluidly connected to fluidic channel 359′ via projecting connector 435 and receiving connector 436. Fluidic channel 359″ travels to cover at least a portion of reference electrode 360 and indicating electrode 375 as shown in FIG. 10. When distal probe portion 450 is operably attached to proximal probe portion 330, fluid can be propelled from reservoir 422 (e.g. propelled by pump assembly 421) to travel through channel 359′, through projecting element 435 and receiving element 436, into channel 359″, and eventually to the locations surrounding reference electrode 360 and indicating electrode 375. Fluid propulsion can be achieved in either direction, such as to withdraw reference solution that has been previously delivered to cover indicating electrode 375. In some embodiments, proximal probe portion 330 is configured to provide at least 5 measurements, such as to be serially attached to at least 5 distal probe portions 450. In some embodiments, proximal probe portion is configured to provide at least 20, at least 50 or at least 100 measurements, such as to be serially attached to at least 20, at least 50 or at least 100 distal probe portions 450, respectively.

In FIG. 10A, probe distal portion 450 has been inserted into probe proximal portion 330, such as by engaging projecting connector 435 with receiving connector 436. Additionally, probe 350 has been inserted into reader 310, such as by inserting the proximal end 352 of probe proximal portion 330 into port 316 of reader 310. Reference solution 500, including one or more reference solutions as have been described hereabove, has been delivered from reservoir 422 to fill a majority of the length of channel 359′. Alternatively or additionally, one or more reference solutions may be propelled from reader 310, from one or more reservoirs not shown but described hereabove. Reference solution 500 can be propelled by pump assembly 421. Pump assembly 421 can be powered, controlled, operated and/or otherwise driven by one or more components of reader 310, such as pump 321 of FIG. 1. In these embodiments, pump assembly 421 and/or a pumping assembly of reader 310, working singly or in combination, can comprise a fluid-contacting or non-fluid-contacting mechanism, such as a mechanism selected from the group consisting of: a translatable plunger or drive mechanism configured to move a plunger of disposable probe 350; a rotating or linear peristaltic fluid drive such as a peristaltic drive configured to propel fluid in tubing of probe 350; a magnetohydrodynamic drive such as a magnetic drive configured to propel a conductive solution in probe 350; and combinations of these. In some embodiments, pump assembly 421 comprises a segment of tubing and reader 310 comprises a linear or rotary peristaltic drive mechanism. In some embodiments, pump assembly 421 comprises one or more fluid driving pistons, and reader 310 includes a drive mechanism configured to translate or otherwise move the pistons to propel fluid.

In FIG. 10B, reference solution 500 has been further delivered through channel 359, through projecting connector 435 and receiving connector 436, and into channel 359″. Reference solution 500 is shown terminating at a location between reference electrode 360 and indicating electrode 375. In a previous step, fluid may have been advanced to additionally cover indicating electrode 375, such as at a location in which a procedure can be performed, such as a calibration procedure such as has been described hereabove, a voltage treatment, or other configuration procedure performed on one or more components of probe 350. After completion of the procedure, the reference solution can be withdrawn, such as via operation of pump assembly 421, to terminate in the location shown in FIG. 10B, such as to be ready to receive a sample solution for pH measurement. In some embodiments, simultaneous with the withdrawal of the reference solution, a sample solution may be drawn into the distal portion of channel 359″, covering indicating electrode 375 and contacting the reference solution to form a liquid junction between indicating electrode 375 and reference electrode 360.

The foregoing description and accompanying drawings set forth a number of examples of representative embodiments at the present time. Various modifications, additions and alternative designs will become apparent to those skilled in the art in light of the foregoing teachings without departing from the spirit hereof, or exceeding the scope hereof, which is indicated by the following claims rather than by the foregoing description. All changes and variations that fall within the meaning and range of equivalency of the claims are to be embraced within their scope.

1. A system for determining a pH measurement comprising:
at least one disposable probe comprising:
at least two electrodes,
wherein a first of the at least two electrodes is in continuous contact with a calibration material and functions as a reference electrode; and
a second of the at least two electrodes is in temporary contact with the calibration material for calibration prior to contact with a sample and functions as an indicating electrode.

2. The system of claim 1 wherein the system is constructed and arranged to provide the pH information based on a measurement of the sample solution based on signals received from the at least one indicating electrode and the at least one reference electrode when the at least one reference electrode is in contact with a reference solution and when the at least one indicating electrode is in contact with the sample, wherein the measurement is selected from the group consisting of a potentiometric measurement, an amperometric measurement, and a resistive measurement.

3. The system of claim 1 wherein the calibration material is a reference solution.

4-7. (canceled)

8. The system of claim 1 wherein the at least one disposable probe is constructed and arranged to provide individual pH measurements for multiple different samples.

9. The system of any one of the previous claims wherein the disposable probe comprises a puncturable access port.

10-13. (canceled)

14. The system of claim 1 wherein the at least two electrodes are constructed of materials selected from the group consisting of: iridium oxide; silicon oxide such as doped silicon oxide; silver-silver chloride; and combinations thereof.

15-22. (canceled)

23. The system of claim 1 further configured to provide an error detection function.

24-26. (canceled)

27. The system of claim 1 further configured to provide a single point calibration procedure.

28. The system of claim 1 further configured to provide a multiple point calibration procedure.

29. (canceled)

30. The system of claim 1 further configured to provide a self-diagnostic function.

31. The system of any one of the previous claims further comprising a removable cover surrounding at least the at least one indicating electrode.

32. A method of determining a pH measurement comprising:
providing a system for pH measurement comprising:
at least one disposable probe comprising:
at least two electrodes,
wherein a first of the at least two electrodes is in continuous contact with a calibration material and functions as a reference electrode, and
a second of the at least two electrodes is in temporary contact with the calibration material for calibration prior to contact with a sample and functions as an indicating electrode;
inserting the disposable probe into the reader; and
bringing the sample into contact with the indicating electrode.

33. A pH measurement system as described in reference to the drawings.

34. A method of determining pH as described in reference to the drawings.

35. The method of claim 32 wherein the calibration material is a reference solution.
